(19) United States
(12) Patent Application Publication
(10) Pub. No.: US 2026/0087454 A1
(43) Pub. Date: Mar. 26, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takahiro SHIMIZU, Tokyo (JP)

(21) Appl. No.: 19/297,889

(22) Filed: Aug. 12, 2025

(30) Foreign Application Priority Data
Sep. 20, 2024 (JP) 2024-164377

(51) Int. Cl. G06Q 10/101; G06Q 30/0601

(52) U.S. Cl. CPC G06Q 10/101; G06Q 30/06031

(57) ABSTRACT

An information processing apparatus includes a registration unit 131 that registers, in response to a request from a business operator who operates a business account that is an account for a business operator established on a mobile messenger application, a plurality of the business accounts cooperating with each other as a business association in association with each other; and a providing unit 132 that provides information to the business operator based on information related to the business operator belonging to the business association.

### CROSS-REFERENCE TO RELATED APPLICATIONS

The present application claims priority to and incorporates by reference the entire contents of Japanese Patent Application No. 2024-164377 filed in Japan on Sep. 20, 2024.

### BACKGROUND OF THE INVENTION

### 1. Field of the Invention

The present application relates to an information processing apparatus, an information processing method, and an information processing program.

### 2. Description of the Related Art

In the related art, mobile messengers have been widely used as one of communication tools usable via mobile communication terminals. For example, a technology of transmitting voice messages between chat participants using a mobile messenger has also been proposed relating to mobile messengers (for example, refer to JP 2007-295576 A).

However, the technology in the related art has room for improvement in enhancing convenience of an official account in a mobile messenger service.

### SUMMARY OF THE INVENTION

An information processing apparatus includes a registration unit that registers, in response to a request from a business operator who operates a business account that is an account for a business operator established on a mobile messenger application, a plurality of the business accounts cooperating with each other as a business association in association with each other; and a providing unit that provides information to the business operator based on information related to the business operator belonging to the business association.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing an example of information processing (part 1) according to an embodiment;

FIG. 2 is a diagram for describing an example of information processing (part 2) according to the embodiment;

FIG. 3 is a diagram illustrating an image of service provision according to the embodiment;

FIG. 4 is a diagram illustrating an image of service provision according to the embodiment;

FIG. 5 is a diagram illustrating a system configuration example of an information processing system according to the embodiment;

FIG. 6 is a diagram illustrating a configuration example of an information processing apparatus according to the embodiment;

FIG. 7 is a diagram illustrating an outline of business operator information stored in a business operator information storage unit according to the embodiment;

FIG. 8 is a diagram illustrating an outline of cooperation information stored in a cooperation information storage unit according to the embodiment;

FIG. 9 is a diagram illustrating an outline of alliance information stored in an alliance information storage unit according to the embodiment;

FIG. 10 is a flowchart illustrating an example of a processing procedure of information processing (part 1) executed by the information processing apparatus according to the embodiment;

FIG. 11 is a flowchart illustrating an example of a processing procedure of information processing (part 2) executed by the information processing apparatus according to the embodiment;

FIG. 12 is a flowchart illustrating an example of a processing procedure of information processing (part 3) executed by the information processing apparatus according to the embodiment; and

FIG. 13 is a hardware configuration diagram illustrating an example of a computer that implements functions of the information processing apparatus according to the embodiment.

### DETAILED DESCRIPTION OF THE PREFERRED EMBODIMENTS

Hereinafter, modes for implementing an information processing apparatus, an information processing method, and an information processing program according to the present application (hereinafter, referred to as “embodiments”) will be described in detail with reference to the drawings. Note that the information processing apparatus, the information processing method, and the information processing program according to the present application are not limited by the embodiments. Each embodiment can be appropriately combined within a range in which processing contents do not contradict each other. In the following embodiments, the same parts are denoted by the same reference numerals, and redundant description will be omitted.

### Embodiment

### 1. Example of Information Processing

### 1-1. Information Processing (Part 1)

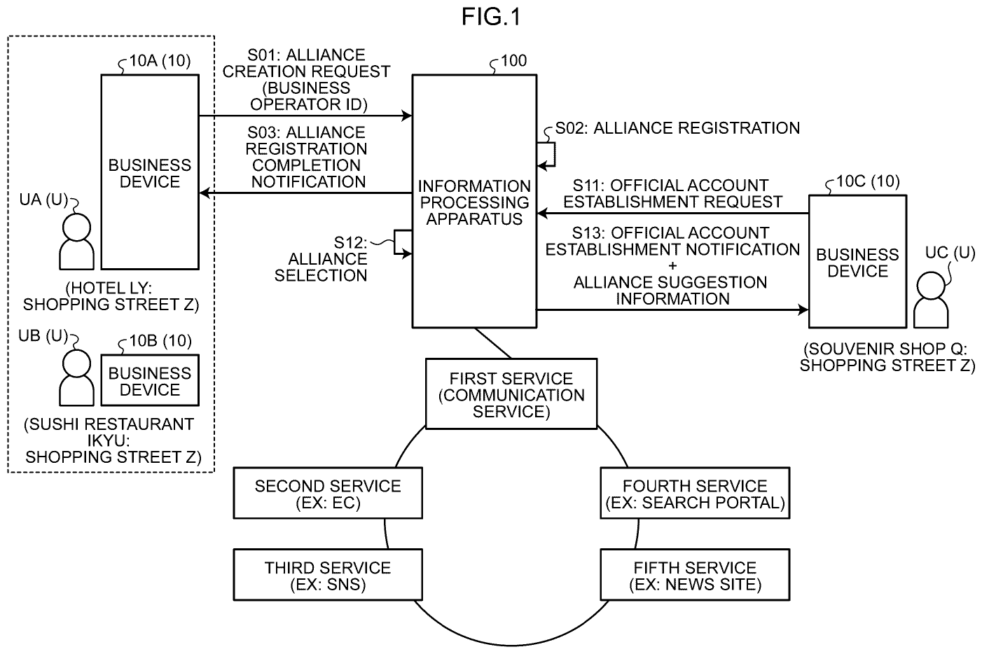

Hereinafter, an example of information processing according to an embodiment will be described with reference to the drawings. First, an outline of information processing (part 1) according to the embodiment will be described with reference to FIG. 1. FIG. 1 is a diagram for describing an example of the information processing (part 1) according to the embodiment. An object of the information processing (part 1) described below is to enhance convenience of an official account in a mobile messenger service by providing a mechanism that provides a consistent service between businesses having the official accounts using a communication service that uses a mobile messenger as a platform.

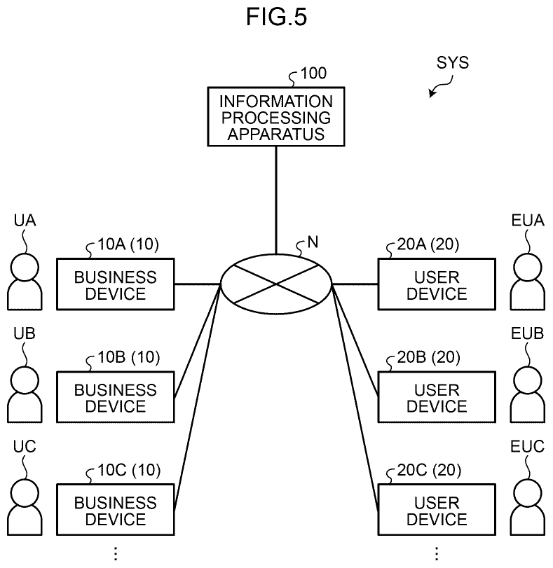

The information processing (part 1) according to the embodiment is realized by an information processing system SYS (for example, refer to FIG. 5) including a business device 10A, a business device 10B, and a business device 10C illustrated in FIG. 1 and an information processing apparatus 100 illustrated in FIG. 1. The business devices 10A to 10C and the information processing apparatus 100 are connected to a network N (for example, refer to FIG. 5) in a wired or wireless manner. The business devices 10A to 10C and the information processing apparatus 100 can communicate with other apparatuses via the network N.

Note that, in the following description, when it is not necessary to particularly distinguish the business device 10A, the business device 10B, and the business device 10C in description, the devices will be collectively referred to as “business device 10”. When it is not necessary to particularly distinguish a business operator UA, a business operator UB, and a business operator UC in description, the operators will be collectively referred to as “business operator U”.

A business device 10 is used by a business operator U. In the business device 10, a mobile messenger application (hereinafter, appropriately referred to as “messenger application”) that is an application program for using a mobile messenger is installed in advance. The business operator U is an example of a business operator who operates an official account (also referred to as “business account”) that is an account for business established on the mobile messenger application.

The official account is an authenticated account authenticated by a service provider of a communication service executed by the messenger application. Unlike a normal account on the message application, the official account can exchange messages with a user of the above-described communication service who follows the official account. The official account can provide a business card, provide a chat service using generative artificial intelligence (AI), distribute an advertisement message, and the like. Generative AI is realized by artificial intelligence (AI) such as a generative pre-trained transformer (GPT), for example. GPT is a language model capable of generating sentence by natural language processing technology.

The above-described communication service enables setting of an alliance that associates the official accounts with each other (an example of a “business association”). As a result, the business operator U who operates the official account can cooperate with other business operators U as an alliance.

For example, the business device 10A transmits an alliance creation request to the information processing apparatus 100 according to an operation by the business operator UA (step S01). An alliance creation request includes a business operator ID for identifying the business operator UA who operates the official account that transmitted the alliance creation request, and a business operator ID for identifying the business operator UB who operates the official account with which cooperation is desired.

Upon receiving the alliance creation request, the information processing apparatus 100 performs alliance registration (step S02). For example, the information processing apparatus 100 registers a business account (business operator ID) of the business operator UA and a business account (business operator ID) of the business operator UB who cooperate with each other as an alliance in association with an alliance ID for specifying the alliance (an example of “association identification information”).

In registration of the alliance, the information processing apparatus 100 may generate information indicating a name of the alliance or information indicating an attribute of the alliance as alliance information and register the information in association with the alliance ID. The attribute of the alliance corresponds to information indicating the business operator U (official account) belonging to the alliance, information indicating an area in which the business operator U belonging to the alliance is located, information indicating a business category (industry type, business state, or the like) of the business operator U belonging to the alliance, and the like. Note that the attributes of the alliance may be registered by the business operator U belonging to the alliance, or may be set by estimation of the generative AI from information related to each business operator belonging to the alliance.

After alliance registration is completed, the information processing apparatus 100 transmits an alliance registration completion notification to the business device 10A (step S03).

The business operator UA confirms the alliance registration completion notification transmitted from the information processing apparatus 100, and thereafter cooperates with the business operator UB as an alliance.

Meanwhile, the business device 10C transmits an official account establishment request to the information processing apparatus 100 according to an operation by a business operator UC (step S11). The business operator UC is a new business operator who newly establishes an official account.

Upon receiving the official account establishment request, the information processing apparatus 100 executes authentication processing based on information of the business operator UC included in the establishment request, and when authentication is successful, the information processing apparatus assigns an official account to the business operator UC.

The information processing apparatus 100 can provide a function of creating a new alliance and a function of joining an existing alliance to the business operator UC who established an official account. For example, the information processing apparatus 100 can provide the business operator UC with the function of creating a new alliance and the function of joining an existing alliance as a part of the functions installed in the messenger application or a part of the functions installed in a predetermined tool provided from the service provider of the communication service to the business operator U. For example, the business operator UC can transmit the above-described alliance creation request to the information processing apparatus 100 by operating the messenger application or the predetermined tool and using the function of creating a new alliance. The business operator UC can transmit a request for joining an existing alliance to the information processing apparatus 100, for example, by operating the messenger application or the predetermined tool and using a join function on the existing alliance. For example, when a request for joining an existing alliance is transmitted from the business operator UC, the information processing apparatus 100 can mediate alliance join by notifying the official account that set the existing alliance of the request for joining the alliance.

The information processing apparatus 100 selects an alliance that matches an attribute of the business operator UC from the existing alliances based on the attributes of the existing alliances and the attribute of the business operator UC who newly established an official account (step S12). For example, in the example illustrated in FIG. 1, since the location of the business operator UC who newly established an official account is “shopping street Z”, the information processing apparatus 100 can select an alliance to which the business operator UA and the business operator UB having the same attribute of “shopping street Z” belong.

After selecting an alliance, the information processing apparatus 100 provides the business operator UC with an official account establishment notification and alliance suggestion information for suggesting participation in the alliance by transmitting the information to the business device 10C (step S13).

The business operator UC can consider participation in the alliance with reference to the alliance suggestion information received from the information processing apparatus 100.

As described above, the information processing apparatus 100 according to the embodiment enables setting of an alliance in which official accounts cooperate with each other, and can provide, for example, suggestion information for suggesting participation in the alliance to a new business operator who established an official account. Accordingly, the information processing apparatus 100 can enhance convenience of an official account in a mobile messenger service.

The communication service provided as a first service and a plurality of services other than the communication service cooperate with each other in advance. For example, user IDs assigned to identify users are associated with each other in each of a communication service provided as a first service, an electronic commerce (EC) provided as a second service, a social networking service (SNS) provided as a third service, a search portal provided as a fourth service, and a news site provided as a fifth service.

The information processing apparatus 100 can provide information based on each service to the official account by the user ID of the user of the communication service. For example, the information processing apparatus 100 acquires attribute information indicating an attribute and a behavior history of the user in each service based on the user ID of each user who follows each official account belonging to the alliance, and generates statistical information based on the acquired attribute information and behavior history. For example, the information processing apparatus 100 can generate various types of statistical information indicating tendencies such as age group, gender, residence, content of another service being used, and an average payment amount in another service of each user who follows each official account belonging to the alliance. Then, the information processing apparatus 100 provides the generated statistical information to each official account.

The information processing apparatus 100 may acquire a behavior history of the user based on each service based on the user ID of each user who follows a first official account belonging to the alliance, and generate statistical information based on the acquired behavior history. Then, the information processing apparatus 100 may provide statistical information related to each user who follows the first official account to a second official account belonging to the same alliance.

The information processing apparatus 100 may calculate a degree of contribution by the alliance to each business operator based on the number of times of predetermined conversion (for example, following) from the alliance, and may acquire a predetermined fee from each business operator based on the calculated degree of contribution. For example, the information processing apparatus 100 assumes that 50 users followed the business operator UA, 30 users followed the business operator UB, and 20 users followed the business operator UC due to provision of alliance information of the alliance to which the business operator UA, the business operator UB, and the business operator UC belong. Here, the information processing apparatus 100 calculates the degree of contribution of the alliance to the business operator UA as 50%, the degree of contribution of the alliance to the business operator UB as 30%, and the degree of contribution of the alliance to the business operator UC as 20%. Then, the information processing apparatus 100 proportionally divides advertising cost generated in response to provision of the alliance information by the degree of contribution, thereby calculating a fee for each business operator U and collecting the calculated fee from each business operator U.

For example, when the business operator UB is followed due to distribution of advertisement of the business operator UB in the official account of the business operator UA, the information processing apparatus 100 may recognize the case as contribution by the business operator UA. Here, the information processing apparatus 100 can assign a part of the fee collected from the business operator UB as a cost for advertisement distribution to the business operator UA according to the degree of contribution of the business operator UA.

### 1-2. Information Processing (Part 2)

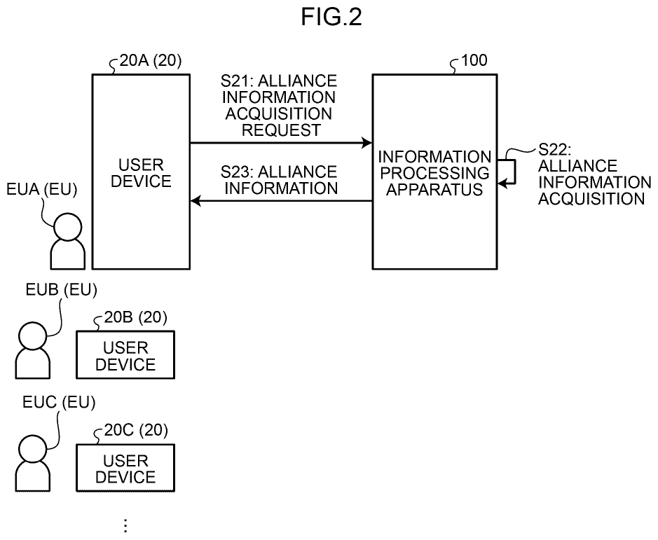

Hereinafter, an outline of information processing (part 2) according to the embodiment will be described with reference to FIG. 2. FIG. 2 is a diagram for describing an example of the information processing (part 2) according to the embodiment. An object of the embodiment described below is to enhance usability of a mobile messenger service by providing a mechanism that provides a consistent service between businesses having the official accounts using a communication service that uses a mobile messenger as a platform.

The information processing (part 2) according to the embodiment is realized by an information processing system SYS (for example, refer to FIG. 5) including a user device 20A, a user device 20B, and a user device 20C illustrated in FIG. 2 and an information processing apparatus 100 illustrated in FIG. 2. The user devices 20A to 20C and the information processing apparatus 100 are connected to a network N (for example, refer to FIG. 5) in a wired or wireless manner. The user devices 20A to 20C and the information processing apparatus 100 can communicate with other apparatuses via the network N.

Note that, in the following description, when it is not necessary to particularly distinguish the user device 20A, the user device 20B, and the user device 20C in description, the devices will be collectively referred to as “user device 20”. When it is not necessary to particularly distinguish a user EUA, a user EUB, and a user EUC in description, the users will be collectively referred to as “user EU”.

A user device 20 is used by a user EU. A messenger application is installed in the user device 20 in advance. A normal account of a message application is assigned to the user EU.

For example, the user EUA operates the user device 20A to activate the messenger application, and transmits a request for acquiring the alliance information to the information processing apparatus 100 via the messenger application (step S21).

For example, the user EUA can select a thumbnail corresponding to a desired alliance from an alliance list displayed on a predetermined screen of the messenger application, thereby transmitting a request for acquiring the alliance information corresponding to the selected thumbnail to the information processing apparatus 100.

Note that, when providing the alliance list to the user EUA via the messenger application, the information processing apparatus 100 may estimate a degree of harmony between the attribute of the alliance and the attribute of the user EUA, and select information of the alliance having high degree of harmony estimated as a target of information provision to the user EUA. For example, when a residence of the user EUA is included in a location area of an alliance EX1, the information processing apparatus 100 can estimate that the degree of harmony between the alliance EX1 and the user EUA is high. The information processing apparatus 100 may estimate the degree of harmony using a learned model or may estimate the degree of harmony based on a rule-based system set in advance.

Upon receiving the acquisition request for alliance information from the user device 20A, the information processing apparatus 100 acquires alliance information corresponding to the acquisition request (step S22). For example, the information processing apparatus 100 acquires information related to an official account belonging to the alliance (name of the official account (for example, store name), homepage URL, and the like) as the alliance information. Then, the information processing apparatus 100 provides the acquired alliance information to the user EUA by transmitting the information to the user device 20A (step S23). For example, the information processing apparatus 100 can provide an account list listing the official accounts included in the alliance as the alliance information to the user EUA by transmitting the account list to the user device 20A.

When providing the account list to the user EUA, the information processing apparatus 100 may estimate the degree of harmony between the attribute of the official account belonging to the account list and the attribute of the user EUA, and rearrange and provide the account list such that the official account having the attribute with high estimated degree of harmony is preferentially displayed. For example, when an age of the user EUA is within the age group of each user who follows the corresponding official account, the information processing apparatus 100 can estimate that the degree of harmony between the attribute of the official account and the attribute of the user EUA is high. For example, when a residence of the user EUA is included in vicinity of a location area of a business operator U who operates the corresponding official account, the information processing apparatus 100 can estimate that the degree of harmony between the attribute of the official account and the attribute of the user EUA is high.

When receiving an acquisition request for information on an official account from the user EUA, the information processing apparatus 100 may select another official account of the alliance to which the official account followed by the user EUA belongs, that is, an official account not followed by the user EUA as an official account to be provided with information to the user EUA. Here, the information processing apparatus 100 may suggest following the selected official account to the user EUA, the user EUA may automatically follow the official account that is not yet followed by the user EUA, or an inquiry for following may be made to the user EUA to execute following when the inquiry is accepted.

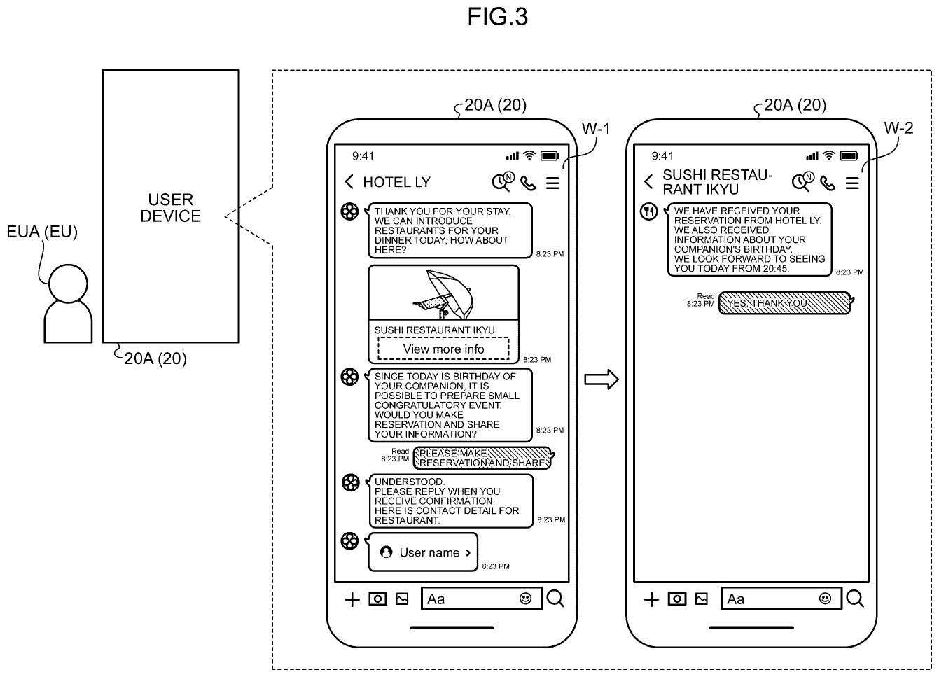

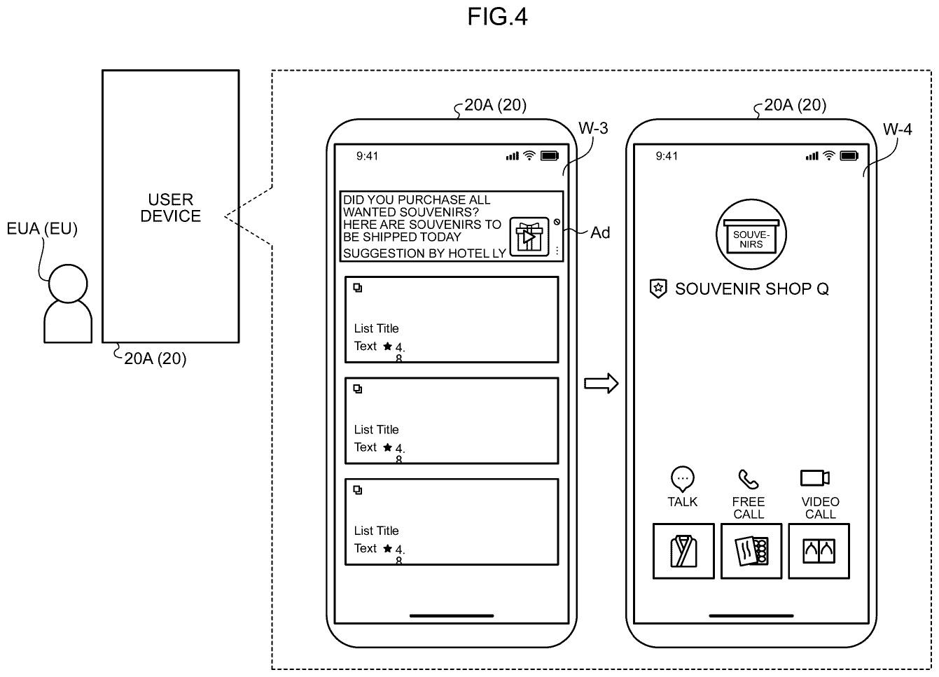

When a request for the second official account of the alliance to which the first official account belongs is received via a predetermined screen on which messages are exchanged between the user EUA and the first official account, the information processing apparatus 100 may cooperate with the second official account regarding information on the request. Hereinafter, a specific image of service will be described with reference to FIGS. 3 and 4. FIGS. 3 and 4 are diagrams illustrating an image of service provision according to the embodiment.

As illustrated in FIG. 3, the user EUA displays a talk screen W-1 (an example of a “predetermined screen”) of a following official account of [Hotel LY] on the user device 20A, and exchanges messages with the official account of [Hotel LY] via the talk screen W-1. Here, during message exchange with the official account of [Hotel LY], the user EUA requests cooperation of user information and reservation of [Sushi restaurant Ikyu] belonging to the same alliance as the official account of [Hotel LY] according to suggestion from [Hotel LY]. Here, the information processing apparatus 100 cooperates with the official account of [Sushi restaurant Ikyu] regarding information on the request on the talk screen W-1. For example, the information processing apparatus 100 cooperates with the official account of [Sushi restaurant Ikyu] regarding a reservation date and time and information on the user EUA. The user EUA displays a talk screen W-2 of the official account of [Sushi restaurant Ikyu] on the user device 20A, and can view a reservation confirmation message transmitted from [Sushi restaurant Ikyu] via the talk screen W-2.

As illustrated in FIG. 4, when the user EUA follows the official account of [Hotel LY], the information processing apparatus 100 can provide advertisement information Ad of [souvenir shop Q] belonging to the same alliance as the official account of [Hotel LY] via a predetermined screen W-3 of the messenger application. For example, the information processing apparatus 100 may use a condition that the official account of [Hotel LY] cooperates with an official account of [Souvenir shop Q] for mutual advertisement distribution. When the user EUA selects the advertisement information Ad, a home screen W-4 of the official account of [Souvenir shop Q] is displayed on the user device 20A.

As described above, the information processing apparatus 100 according to the embodiment can provide information on alliance and information on an official account to the user of the communication service (for example, user EUA or the like) via the messenger application, and can provide seamless user experience in the communication service. Accordingly, the information processing apparatus 100 can enhance usability of the mobile messenger service.

### 2. System Configuration

Hereinafter, a configuration of the information processing system SYS according to the embodiment will be described in detail with reference to FIG. 5. FIG. 5 is a diagram illustrating a system configuration example of the information processing system SYS according to the embodiment.

As illustrated in FIG. 5, the information processing system SYS according to the embodiment includes a plurality of business devices 10 such as the business device 10A, the business device 10B, and the business device 10C, a plurality of user devices 20 such as the user device 20A, the user device 20B, and the user device 20C, and the information processing apparatus 100. Note that FIG. 5 merely illustrates an example of the configuration of the information processing system SYS according to the embodiment, and the information processing system SYS may include other devices such as a service provision device that executes processing related to a portal site providing various online services.

The business device 10, the user device 20, and the information processing apparatus 100 are connected to the network N in a wired or wireless manner. Each of the business device 10, the user device 20, and the information processing apparatus 100 can communicate with other apparatuses via the network N.

The network N includes, for example, a wide area network (WAN) such as the Internet, or a mobile communication network such as long term evolution (LTE), fourth generation (4G), or fifth generation mobile communication system (5G).

The business device 10 is connected to the network N by short-range wireless communication such as a mobile communication network, Bluetooth (registered trademark), or a wireless local area network (LAN), and can communicate with other apparatuses such as the information processing apparatus 100 via the network N.

The business device 10 is used by the business operator U using the messenger application. The business device 10 may be, for example, a laptop personal computer (PC), a desktop PC, a smartphone, a tablet PC, or the like.

The business operator U starts the messenger application by operating the business device 10 and can transmit an alliance creation request or the like to the information processing apparatus 100 via the messenger application. The business operator U accesses the information processing apparatus 100 by an application programming interface (API) provided by a service provider who manages the information processing apparatus 100, and may transmit an alliance creation request or the like via a predetermined tool displayed on the business device 10 as a user interface. The predetermined tool may be a dedicated application program having various functions for executing processing such as transmission of an alliance creation request, or may be a predetermined management screen that can be displayed as a web page by a web browser.

For example, the business device 10 can display content provided from the information processing apparatus 100 by a dedicated application or a web browser. Note that when the business device 10 receives control information for realizing information display processing from the information processing apparatus 100, the business device 10 realizes display processing according to the control information.

The control information is described in, for example, a script language such as JavaScript (registered trademark), a style sheet language such as cascading style sheets (CSS), a programming language such as Java (registered trademark), or a markup language such as HyperText Markup Language (HTML). Note that a predetermined application distributed from the information processing apparatus 100 or the like may be regarded as control information.

The user device 20 is connected to the network N by short-range wireless communication such as a mobile communication network, Bluetooth (registered trademark), or a wireless local area network (LAN), and can communicate with other apparatuses such as the information processing apparatus 100 via the network N.

The user device 20 is used by the user EU using the messenger application. The user device 20 may be, for example, a laptop personal computer (PC), a desktop PC, a smartphone, a tablet PC, or the like.

The user EU starts the messenger application by operating the user device 20 and can transmit a request for acquiring alliance information or the like to the information processing apparatus 100 via the messenger application.

For example, the user device 20 can display content provided from the information processing apparatus 100 by a dedicated application or a web browser. Note that when the user device 20 receives control information for realizing information display processing from the information processing apparatus 100, the user device 20 realizes display processing according to the control information.

The control information is described in, for example, a script language such as JavaScript (registered trademark), a style sheet language such as cascading style sheets (CSS), a programming language such as Java (registered trademark), or a markup language such as HyperText Markup Language (HTML). Note that a predetermined application distributed from the information processing apparatus 100 or the like may be regarded as control information.

The information processing apparatus 100 is operated and managed by a service provider who provides a communication service via a mobile messenger. The information processing apparatus 100 functions as an online platform that realizes information processing related to a mobile messenger. The information processing apparatus 100 can provide a function of creating a new alliance and a function of joining an existing alliance to an authorized official account.

The information processing apparatus 100 is typically a server device, but may be realized by a mainframe, a workstation, or the like. When the information processing apparatus 100 is realized by a server device, the information processing apparatus may be realized by a single server device, or may be realized by a cloud system or the like in which a plurality of server devices and a plurality of storage devices operate in connection.

### 3. Apparatus Configuration

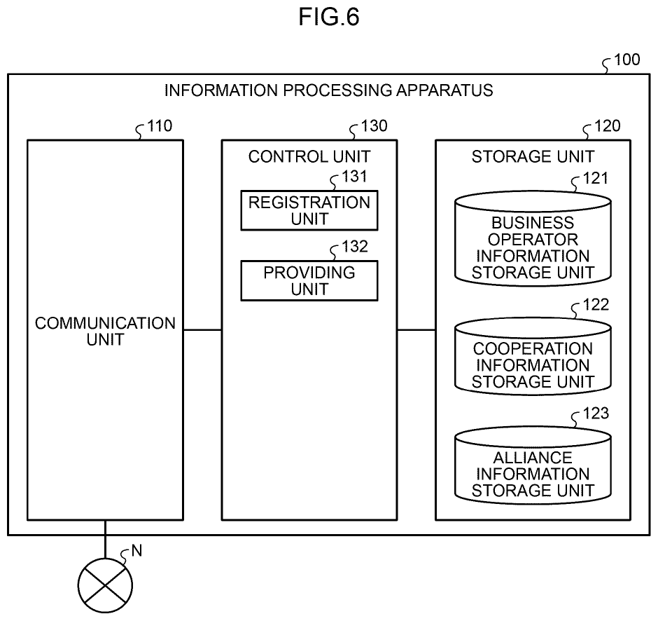

Hereinafter, an example of a functional configuration of the information processing apparatus 100 in the information processing system SYS according to the embodiment will be described with reference to FIG. 6.

FIG. 6 is a diagram illustrating a configuration example of an information processing apparatus 100 according to the embodiment. As illustrated in FIG. 6, the information processing apparatus 100 includes a communication unit 110, a storage unit 120, and a control unit 130.

### Communication Unit 110

The communication unit 110 is realized by, for example, a communication module, a network interface card (NIC), or the like. The communication unit 110 is connected to the network N in a wired or wireless manner.

The information processing apparatus 100 transmits and receives information to and from other apparatuses such as the business device 10 via the network N.

### Storage Unit 120

The storage unit 120 stores, for example, programs and data used for control and calculation by the control unit 130. For example, the storage unit 120 is realized by a semiconductor memory element such as a random access memory (RAM) or a flash memory, or a storage device such as a hard disk or an optical disk. For example, the storage unit 120 includes a business operator information storage unit 121, a cooperation information storage unit 122, and an alliance information storage unit 123. Note that the storage unit 120 is not particularly limited to the example illustrated in FIG. 6, and can appropriately store data necessary for executing the information processing according to the embodiment such as a database that stores user information in various online services. Note that a search history in the various online services may be acquired from other systems as necessary.

### Business Operator Information Storage Unit 121

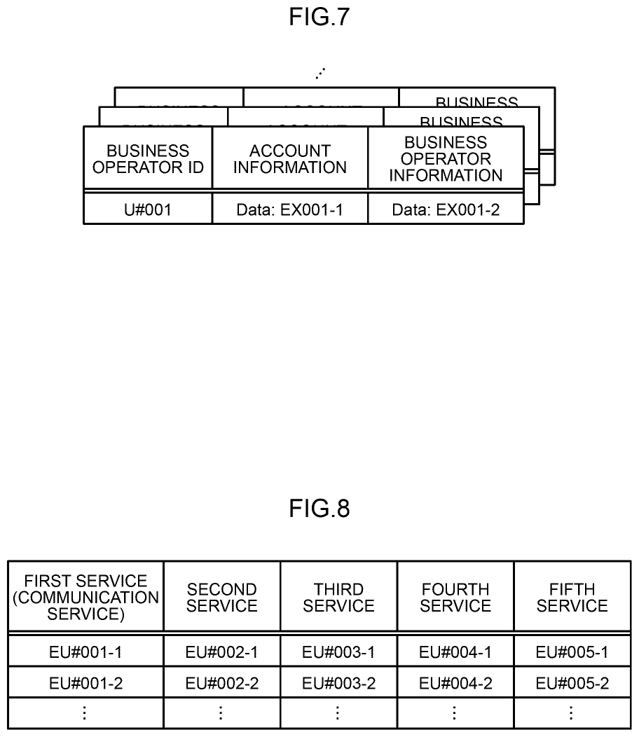

The business operator information storage unit 121 stores business operator information on the business operator U as a user of the communication service via the messenger application. FIG. 7 is a diagram illustrating an outline of the business operator information stored in the business operator information storage unit 121 according to the embodiment.

As illustrated in FIG. 7, the business operator information stored in the business operator information storage unit 121 includes a plurality of items such as an item of “business operator ID”, an item of “account information”, and an item of “business operator information”. The items included in the business operator information are associated with each other.

In the item of “business operator ID”, identification information for specifying the business operator U in the communication service is stored. In the item of “account information”, information of an official account used by the business operator in the communication service is stored. In the item of “business operator information”, information such as an industry type, a business state, and a business base of the business operator U is stored.

### Cooperation Information Storage Unit 122

The cooperation information storage unit 122 stores cooperation information in which a communication service via a messenger application and a plurality of services other than the communication service cooperate with each other in advance. FIG. 8 is a diagram illustrating an outline of the cooperation information stored in the cooperation information storage unit 122 according to the embodiment.

The cooperation information stored in the cooperation information storage unit 122 is configured by mutually cooperating information on each user of the first service that is a communication service and information on each user of each service of the second service, the third service, the fourth service, and the fifth service other than the communication service. For example, as illustrated in FIG. 8, user IDs assigned to identify users are associated with each other in each of a communication service provided as the first service, an electronic commerce (EC) provided as the second service, a social networking service (SNS) provided as the third service, a search portal provided as the fourth service, and a news site provided as the fifth service, as the cooperation information stored in the cooperation information storage unit 122.

For example, a service user who provides the communication service using the messenger application collects a user ID of a user of the communication service from a service other than the communication service in association with the user ID, and registers the collected user ID in association with the user ID of the communication service. The control unit 130 can use the cooperation information stored in the cooperation information storage unit 122 when generating statistical information indicating a tendency of users who follow an official account.

### Alliance Information Storage Unit 123

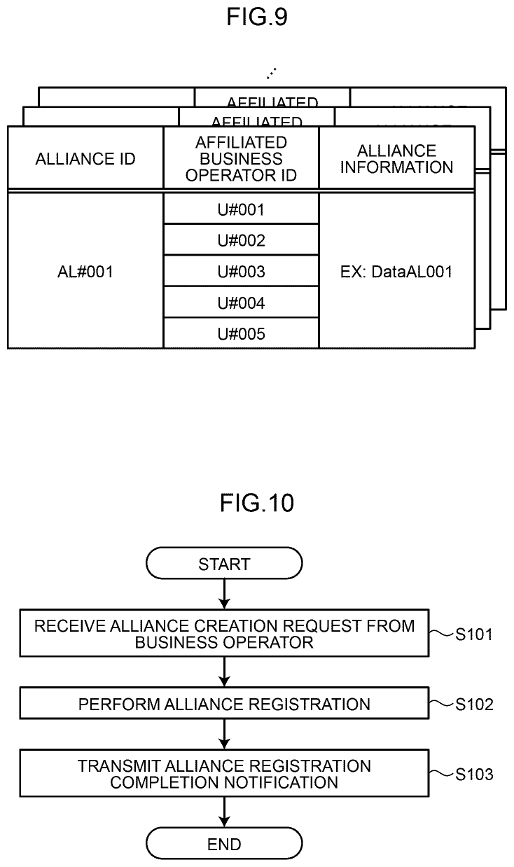

The alliance information storage unit 123 stores alliance information related to an alliance in which official accounts are associated with each other in a communication service. FIG. 9 is a diagram illustrating an outline of the alliance information stored in the alliance information storage unit 123 according to the embodiment.

As illustrated in FIG. 9, the alliance information stored in the alliance information storage unit 123 includes a plurality of items such as an item of “alliance ID”, an item of “affiliated business operator ID”, and an item of “alliance information”. The items included in the alliance information are associated with each other.

In the item of “alliance ID”, an alliance ID that is identification information uniquely assigned to each alliance to identify the alliance is stored. In the item of “affiliated business operator ID”, a business operator ID for specifying a business operator who operates an official account participating in the alliance is stored. In the item of “alliance information”, information on the alliance is stored.

The information on the alliance includes information indicating a name of the alliance, information indicating an attribute of the alliance, and the like. The attribute of the alliance corresponds to information indicating the business operator U (official account) belonging to the alliance, information indicating an area in which the business operator U belonging to the alliance is located, information indicating a business category (industry type, business state, or the like) of the business operator U belonging to the alliance, and the like. Note that the attributes of the alliance may be registered by the business operator U belonging to the alliance, or may be set by estimation of the generative AI from information related to each business operator belonging to the alliance.

Note that, here, a generative AI is realized by, for example, artificial intelligence (AI) such as a generative pre-trained transformer (GPT). GPT is a language model capable of generating sentence by natural language processing technology.

### Control Unit 130

The control unit 130 is a controller, and is realized by a central processing unit (CPU), a micro processing unit (MPU), or the like executing various programs (example of “information processing program”) stored in a storage device inside the information processing apparatus 100 using a RAM as a work area.

The control unit 130 may be realized by, for example, an integrated circuit such as an application specific integrated circuit (ASIC), a field programmable gate array (FPGA), or a general purpose graphic processing unit (GPGPU).

As illustrated in FIG. 6, the control unit 130 includes a registration unit 131 and a providing unit 132, and the units implement or execute a function and an action of information processing described below.

Note that the control unit 130 may be provided with a plurality of divided internal configurations in units of processing for realizing or executing functions and actions of information processing described below. The control unit 130 is not limited to the configuration illustrated in FIG. 6, and may have another configuration as long as the configuration performs information processing described below, and may include another functional unit other than the functional unit illustrated in FIG. 6.

### Registration Unit 131

In response to a request from the business operator U who operates an official account (an example of “business account”) that is an account for business established by the business operator U on the mobile messenger application, the registration unit 131 associates a plurality of official accounts cooperating with each other as an alliance (an example of “business association”) and registers the official accounts in the storage unit 120 (the alliance information storage unit 123). For example, the registration unit 131 registers a plurality of official accounts cooperating with each other as an alliance in association with an alliance ID for specifying the alliance.

### Providing Unit 132

The providing unit 132 provides information to the business operator U based on information related to the business operator U belonging to the alliance.

For example, the providing unit 132 can select an alliance that matches an attribute of a new business operator who newly established an official account based on an attribute of the alliance and the attribute of the new business operator, and transmit suggestion information for suggesting participation to the selected alliance to the business device 10 used by the new business operator via the communication unit 110. Specifically, when a location of the business operator UC who newly established an official account is “shopping street Z”, the providing unit 132 can select an alliance to which the business operator UA and the business operator UB having the same attribute of “shopping street Z”belong.

For example, the providing unit 132 can provide a function of creating a new alliance and a function of joining an existing alliance to a new business operator who newly establishes an official account. For example, the providing unit 132 can provide a function of creating a new alliance and a function of joining an existing alliance as a part of functions of a messenger application or a part of a predetermined tool.

For example, the providing unit 132 can provide information based on information on an information disclosure range preset by the business operator U as a range of information to be disclosed to another official account. For example, the providing unit 132 can provide an item setting screen for setting a range of information to be disclosed to the business operator UA who operates an official account. The providing unit 132 stores information on an information disclosure range set by the business operator UA via the item setting screen in the storage unit 120 in association with the business operator ID. Then, when the providing unit 132 discloses information on the business operator UA to the business operator UB and the business operator UC belonging to the same alliance as the business operator UA, information to be provided to the business operator UB and the business operator UC can be determined based on information on an information disclosure range of the business operator UA. For example, when the business operator UA sets only an age group and a gender of a user (for example, the user EUA, the user EUB, the user EUC, or the like illustrated in FIG. 2) following the official account of the business operator UA as the information disclosure range, only information on the age group and the gender of the business operator UB and the business operator UC can be provided.

The providing unit 132 provides information related to the alliance to the user EUA of the mobile messenger application capable of exchanging messages with the official account based on the information related to the business operator U belonging to the alliance.

When the providing unit 132 receives an acquisition request for information related to the alliance from the user EUA, the providing unit can estimate a degree of harmony between the attribute of the alliance and the attribute of the user, and select information of an alliance having high degree of harmony estimated as a target of information provision to the user EUA.

Specifically, when a residence of the user EUA is included in a location area of an alliance EX1, the providing unit 132 can estimate that the degree of harmony between the alliance EX1 and the user EUA is high. The information processing apparatus 100 may estimate the degree of harmony using a learned model or may estimate the degree of harmony based on a rule-based system set in advance. Then, the providing unit 132 acquires information related to the official account belonging to the alliance (name of the official account (for example, store name), a homepage URL, and the like) as the alliance information, and transmits the acquired alliance information to the user device 20A via the communication unit 110, thereby providing the acquired alliance information to the user EUA. For example, the providing unit 132 can provide an account list listing the official accounts included in the alliance as the alliance information to the user EUA.

When providing the account list to the user EUA, the providing unit 132 may estimate the degree of harmony between the attribute of the official account belonging to the account list and the attribute of the user EUA, and rearrange and provide the account list such that the official account having the attribute with high estimated degree of harmony is preferentially displayed. For example, when an age of the user EUA is within the age group of each user who follows the corresponding official account, the providing unit 132 can estimate that the degree of harmony between the attribute of the official account and the attribute of the user EUA is high. For example, when a residence of the user EUA is included in vicinity of a location area of a business operator U who operates the corresponding official account, the providing unit 132 can estimate that the degree of harmony between the attribute of the official account and the attribute of the user EUA is high.

When the providing unit receives an acquisition request for information on an official account from a user, the providing unit 132 can select another official account of the alliance to which the official account followed by the user belongs, that is, an official account not followed by the user as an official account to be provided with information to the user.

When a request for the second official account of the alliance to which the first official account belongs is received via a predetermined screen on which messages are exchanged between the user and the first official account, the providing unit 132 can cooperate with the second official account regarding information on the request. That is, the providing unit 132 supports sending of customers between official accounts by cooperating information of users related to provision of a transaction item such as a product or a service by the official accounts belonging to the same alliance.

For example, it is assumed that the user EUA who follows the official account of [Hotel LY] exchanges messages with the official account of [Hotel LY] via a talk screen W-1 (an example of “predetermined screen”, refer to FIG. 3) of the official account of [Hotel LY]. Here, when the user EUA requests reservation for [Sushi restaurant Ikyu] belonging to the same alliance as the official account of [Hotel LY] and cooperation of user information according to suggestion from [Hotel LY] while exchanging messages with the official account of [Hotel LY], the providing unit 132 can cooperate with the business operator U by transmitting information related to the request on the talk screen W-1 to the business device 10 of the business operator U operating the official account of [Sushi restaurant Ikyu] via the communication unit 110.

### 4. Processing Procedure According to Embodiment

### 4-1. Processing Procedure of Information Processing (Part 1)

Hereinafter, a processing procedure of the information processing (part 1) executed by the information processing apparatus 100 according to the embodiment will be described with reference to FIG. 10. FIG. 10 is a flowchart illustrating an example of the processing procedure of the information processing (part 1) executed by the information processing apparatus 100 according to the embodiment. The processing procedure illustrated in FIG. 10 is executed by the control unit 130 of the information processing apparatus 100. The processing procedure illustrated in FIG. 10 is repeatedly executed while the information processing apparatus 100 is in operation.

As illustrated in FIG. 10, upon receiving an alliance creation request from the business operator U (step S101), the registration unit 131 performs alliance registration (step S102). For example, the registration unit 131 receives an alliance creation request transmitted from the business device 10 via the communication unit 110.

When the alliance registration is completed, the registration unit 131 notifies the business operator U, who is a transmission source of the alliance creation request, of alliance registration completion (step S103), and ends the processing procedure illustrated in FIG. 10. For example, the registration unit 131 notifies the business operator U by transmitting an alliance registration completion notification to the business device 10 via the communication unit 110.

### 4-2. Processing Procedure of Information Processing (Part 2)

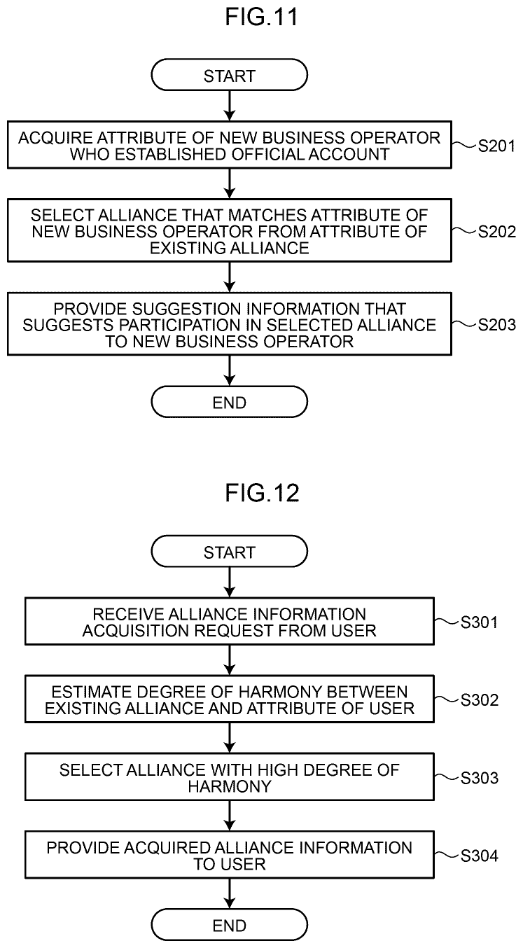

Hereinafter, a processing procedure of the information processing (part 2) executed by the information processing apparatus 100 according to the embodiment will be described with reference to FIG. 11. FIG. 11 is a flowchart illustrating an example of the processing procedure of the information processing (part 2) executed by the information processing apparatus 100 according to the embodiment. The processing procedure illustrated in FIG. 11 is executed by the control unit 130 of the information processing apparatus 100. The processing procedure illustrated in FIG. 11 is repeatedly executed while the information processing apparatus 100 is in operation.

As illustrated in FIG. 11, the providing unit 132 acquires an attribute of a new business operator who newly established an official account in association with the new establishment of the official account (step S201).

The providing unit 132 selects an alliance matching an attribute of the new business operator from existing alliances based on attributes of the existing alliances and the attribute of the new business operator (step S202).

The providing unit 132 provides suggestion information for suggesting participation in the selected alliance to the new business operator (step S203), and ends the processing procedure illustrated in FIG. 11. For example, the providing unit 132 provides suggestion information to the new business operator by transmitting the suggestion information to the business device 10 via the communication unit 110.

### 4-3. Processing Procedure of Information Processing (Part 3)

Hereinafter, a processing procedure of the information processing (part 3) executed by the information processing apparatus 100 according to the embodiment will be described with reference to FIG. 12. FIG. 12 is a flowchart illustrating an example of the processing procedure of the information processing (part 3) executed by the information processing apparatus 100 according to the embodiment. The processing procedure illustrated in FIG. 12 is executed by the control unit 130 of the information processing apparatus 100. The processing procedure illustrated in FIG. 12 is repeatedly executed while the information processing apparatus 100 is in operation.

As illustrated in FIG. 12, the providing unit 132 receives an alliance information acquisition request from a user of a communication service via a messenger application (step S301). For example, the providing unit 132 accepts the alliance information acquisition request transmitted from the user device 20 via the communication unit 110.

The providing unit 132 individually estimates a degree of harmony between an attribute of an existing alliance and an attribute of the user who is an alliance information acquisition request source (step S302), and selects an alliance with high estimated degree of harmony (step S303).

The providing unit 132 acquires information on the selected alliance, provides the acquired information on the alliance to the user who is the alliance information acquisition request source (step S304), and ends the processing procedure illustrated in FIG. 12. For example, the providing unit 132 transmits the information on the alliance to the user device 20 via the communication unit 110, thereby providing the information to the user who is the alliance information acquisition request source.

### 5. Hardware Configuration

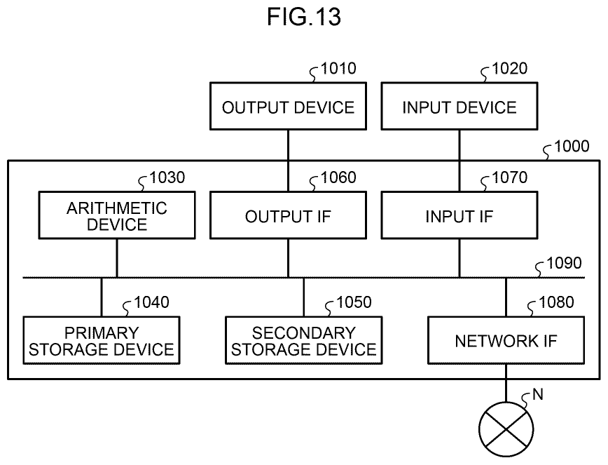

The information processing apparatus 100 according to the above-described embodiment is realized by, for example, a computer 1000 having a configuration as illustrated in FIG. 13. FIG. 13 is a hardware configuration diagram illustrating an example of a computer that implements functions of the information processing apparatus 100 according to the embodiment.

The computer 1000 is connected to an output device 1010 and an input device 1020, and has a form in which an arithmetic device 1030, a primary storage device 1040, a secondary storage device 1050, an output interface (IF) 1060, an input IF 1070, and a network IF 1080 are connected by a bus 1090.

The arithmetic device 1030 operates based on a program stored in the primary storage device 1040 or the secondary storage device 1050, a program read from the input device 1020, or the like, and executes various processes. The primary storage device 1040 is a memory device such as a RAM that primarily stores data used by the arithmetic device 1030 for various arithmetic operations. The secondary storage device 1050 is a storage device in which data used for various arithmetic operations by the arithmetic device 1030 and various databases are registered, and is realized by a read only memory (ROM), an HDD, a flash memory, and the like.

The output IF 1060 is an interface for transmitting information to be output to the output device 1010 such as a monitor and a printer that outputs various types of information, and is realized by, for example, a standard connector such as a universal serial bus (USB), a digital visual interface (DVI), or a high definition multimedia interface (HDMI) (registered trademark). The input IF 1070 is an interface for receiving information from various input devices 1020 such as a mouse, a keyboard, and a scanner, and is realized by, for example, a USB or the like.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like. The input device 1020 may be an external storage medium such as a USB memory.

The network IF 1080 receives data from other devices via the network N, transmits the received data to the arithmetic device 1030, and transmits data generated by the arithmetic device 1030 to other devices via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information processing apparatus 100 according to the embodiment, the arithmetic device 1030 of the computer 1000 realizes the same functions as the control unit 130 by executing a program (for example, an information processing program) loaded on the primary storage device 1040. That is, the arithmetic device 1030 implements processing by the information processing apparatus 100 according to the embodiment in cooperation with a program (for example, the information processing program) loaded on the primary storage device 1040.

### 6. Others

In the above embodiment, the information processing apparatus 100 may cooperate the information on the user between the official accounts under a condition that the user of the communication service (for example, the user EUA illustrated in FIG. 2, or the like) accepts.

The information processing apparatus 100 may distribute an alliance advertisement related to the alliance via the messenger application. For example, the information processing apparatus 100 acquires alliance information stored in the alliance information storage unit 123, creates a landing page with the acquired alliance information, and provides the landing page via the messenger application. The information processing apparatus 100 can select information to be posted on the landing page from not only information on the official account but also from entire services connected to the alliance. For example, information that can be selected by the information processing apparatus 100 may include distribution information and a use method of an official account, information on a mini-application provided from the official account, a reservation link via the official account, inventory information regarding EC, and the like.

The information processing apparatus 100 may distribute all advertisements of the official accounts belonging to the alliance targeting each user who follows the official account belonging to the alliance.

The information processing apparatus 100 may distribute an advertisement according to a situation of a user (for example, the user EUA illustrated in FIG. 2, or the like) of the communication service. For example, the providing unit 132 may analyze contents of messages exchanged between the user and the official account, select an advertisement of the official account that exchanges messages or an advertisement related to another official account of the alliance to which the official account belongs according to the situation of the user based on analyzed contents of the messages, and provide the selected advertisement to the user.

The providing unit 132 may select an advertisement according to the situation of the user based on a series of behavior contents of the user via a plurality of the official accounts belonging to the same alliance, and provide the selected advertisement to the user. For example, when the providing unit 132 uses an official account of a movie theater SH-1 belonging to an alliance of a shopping mall SM and subsequently acquires behavior information on the user using a restaurant SH-2, the providing unit 132 may provide an advertisement related to a time-limit discount or coupon distribution of a clothing brand SH-3 belonging to the alliance of the shopping mall SM.

In the above-described embodiment, the information processing apparatus 100 may calculate a degree of contribution by the alliance to each business operator based on the number of times of predetermined conversion from the alliance, and may acquire a predetermined fee from each business operator based on the calculated degree of contribution.

For example, the information processing apparatus 100 assumes that 50 users followed the business operator UA, 30 users followed the business operator UB, and 20 users followed the business operator UC due to provision of alliance information of the alliance to which the business operator UA, the business operator UB, and the business operator UC belong. Here, the information processing apparatus 100 calculates the degree of contribution of the alliance to the business operator UA as 50%, the degree of contribution of the alliance to the business operator UB as 30%, and the degree of contribution of the alliance to the business operator UC as 20%. Then, the information processing apparatus 100 proportionally divides advertising cost generated in response to provision of the alliance information by the degree of contribution, thereby calculating a fee for each business operator U and collecting the calculated fee from each business operator U.

For example, when the business operator UB is followed due to distribution of advertisement of the business operator UB in the official account of the business operator UA (when customers are sent), the information processing apparatus 100 may recognize the case as contribution by the business operator UA as a sender. Here, the information processing apparatus 100 can assign a part of the fee collected from the business operator UB as a cost for advertisement distribution to the business operator UA according to the degree of contribution of the business operator UA.

Among the processes described in the above embodiments and the like, all or a part of the processes described as being automatically performed can be manually performed, or all or a part of the processes described as being manually performed can be automatically performed by a known method. The processing procedures, specific names, and information including various types of data and parameters illustrated in the document and the drawings can be freely changed unless otherwise specified.

Each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in units that are freely set according to various loads, usage conditions, and the like.

The above-described embodiments can be appropriately combined within a range in which processing contents do not contradict each other.

Although the embodiments of the present application have been described in detail with reference to some drawings, the descriptions are merely examples, and the present invention can be implemented in other forms to which various modifications and improvements have been made based on the knowledge of those skilled in the art, including the aspects described in the disclosure of the invention.

“Part (section, module, unit)” described above can be replaced with “means”, “circuit”, or the like. For example, the control unit can be replaced with a control means or a control circuit.

### 7. Effects

The information processing apparatus 100 according to the embodiment includes the registration unit 131 and the providing unit 132. In response to a request from a business operator who operates an official account (an example of “business account”) that is an account for business established on a mobile messenger application, the registration unit 131 associates a plurality of official accounts cooperating with each other as an alliance (an example of “business association”) and registers the official accounts. The providing unit 132 provides information to the business operator U based on information related to the business operator U belonging to the alliance.

The registration unit 131 registers a plurality of official accounts cooperating with each other as an alliance in association with an alliance ID for specifying the alliance.

The providing unit 132 selects an alliance that matches an attribute of a new business operator who newly established an official account based on an attribute of the alliance and the attribute of the new business operator, and transmits suggestion information for suggesting participation to the selected alliance to the business device 10 used by the new business operator via the communication unit 110.

The providing unit 132 provides a function of creating a new alliance and a function of joining an existing alliance to a new business operator.

The providing unit 132 provides information based on information on a provision range preset by the business operator U as a range of information to be provided to another official account.

Therefore, the information processing apparatus 100 according to the embodiment enables setting of an alliance in which official accounts cooperate with each other, and can provide suggestion information for suggesting participation in the alliance to a new business operator who established an official account. Accordingly, the information processing apparatus 100 can enhance convenience of an official account in a mobile messenger service.

The above-described effect can also be realized by a combination of any of the processing executed by each unit described above and the processing executed by each unit.

According to one aspect of the embodiment, it is possible to enhance convenience of an official account in a mobile messenger service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a registration unit that registers, in response to a request from a business operator who operates a business account that is an account for a business operator established on a mobile messenger application, a plurality of the business accounts cooperating with each other as a business association in association with each other; and
a providing unit that provides information to the business operator based on information related to the business operator belonging to the business association.

2. The information processing apparatus according to claim 1, wherein
the registration unit registers a plurality of the business accounts cooperating with each other as a business association in association with association identification information for specifying the business association.

3. The information processing apparatus according to claim 2, wherein
the providing unit selects the business association that matches an attribute of a new business operator who newly established the business account based on an attribute of the business association and the attribute of the new business operator and transmits suggestion information for suggesting participation to the selected business association to a business device used by the new business operator.

4. The information processing apparatus according to claim 3, wherein
the providing unit provides a function of newly creating the business association and a function of joining the existing business association to the new business operator.

5. The information processing apparatus according to claim 1, wherein
the providing unit provides information based on information on a provision range preset by the business operator as a range of information to be provided to another business account.

6. An information processing method executed by a computer, the method comprising steps of:
registering, in response to a request from a business operator who operates a business account that is an account for a business operator established on a mobile messenger application, a plurality of the business accounts cooperating with each other as a business association in association with each other; and
providing information to the business operator based on information related to the business operator belonging to the business association.

7. A non-transitory computer readable storage medium having stored therein an information processing program that causes a computer to execute a process, the process comprising:
a registration procedure of registering, in response to a request from a business operator who operates a business account that is an account for a business operator established on a mobile messenger application, a plurality of the business accounts cooperating with each other as a business association in association with each other; and
a provision procedure of providing information to the business operator based on information related to the business operator belonging to the business association.
